(19) United States
(12) Patent Application Publication
(10) Pub. No.: US 2022/0066800 A1
(43) Pub. Date: Mar. 3, 2022

(54) SYSTEM AND METHOD FOR PROVIDING A VIRTUAL PRODUCTIVITY ASSISTANT

(71) Applicant: JPMORGAN CHASE BANK, N.A., New York, NY (US)

(72) Inventors: Davinder P. SINGH, Bengaluru (IN); Prashant MEKARAJ, Bengaluru (IN); Siddharth JAMDAR, Bengaluru (IN); Craig Andrew RITCHIE, Ashtead (GB); Ajay Suryanarayana GUPTA, Bengaluru (IN)

(21) Appl. No.: 17/461,861

(22) Filed: Aug. 30, 2021

(30) Foreign Application Priority Data
Aug. 28, 2020 (IN) 202011037174

(51) Int. Cl. G06F 9/451; G06F 16/23; G06F 3/0481; G06Q 10/10

(52) U.S. Cl. CPC G06F 9/453; G06Q 10/1095; G06F 3/0481; G06F 16/2379

(57) ABSTRACT

Systems and methods for executing a virtual assistant system are disclosed. The method includes presenting, a skill programming interface. The method may further include receiving, and from the skill programming interface, a user input. The method may further include creating, a command based on input received by the user interface. The method may further include generating, a workflow based on the command, wherein the workflow includes a first skill associated with the command. The method may further include identifying, a dependent skill from a plurality of dependent skills based on the first skill and the command. The method may further include generating, a skill graph comprising a set of compatible skills and a set of incompatible skills. The method may further include compiling, the command including the workflow and the first skill; and executing, the command.

### CROSS-REFERENCE TO RELATED APPLICATION

This application claims priority to Indian Patent Application No. 202011037174, filed in India on 28 Aug. 2020.

### BACKGROUND

### 1. Technical Field

The present disclosure generally relates to systems and methods for providing a virtual productivity assistant.

### 2. Description of Related Art

Employees spend a significant amount of their time navigating a large organization, from finding people to joining meetings. Each activity that they undertake requires them to navigate multiple steps, which takes a considerable amount of time.

### SUMMARY

Systems and methods for executing a virtual assistant system. According to one embodiment, the method includes presenting, by a computer program, a skill programming interface. The method may further include receiving, by the computer program and from the skill programming interface, a user input. The method may further include creating, by the computer program, a command based on input received by the user interface. The method may further include generating, by the computer program, a workflow based on the command, wherein the workflow includes a first skill associated with the command. The method may further include identifying, by the computer program, a dependent skill from a plurality of dependent skills based on the first skill and the command. The method may further include generating, by the computer program, a skill graph comprising a set of compatible skills and a set of incompatible skills. The method may further include compiling, by the computer program, the command including the workflow and the first skill; and executing, by the computer program, the command.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts an example of system for providing a virtual productivity assistant is illustrated, according to embodiments of the present disclosure.

FIG. 2 depicts a process flow for providing a virtual productivity assistant is illustrated, according to embodiments of the present disclosure.

FIG. 3 depicts an example of generating a workflow for a virtual productivity assistant is illustrated, according to embodiments of the present disclosure.

### DETAILED DESCRIPTION OF PREFERRED EMBODIMENTS

In some embodiments, the method may include identifying, by a computer program, a dependent skill from a plurality of dependent skills based on the first skill and the command. The method may further include accessing, by the computer program, a database including a plurality of skills. The method may further include linking, by the computer program, a dependent skill to the first skill, wherein linking comprises generating, by a machine learning model, an association between the dependent skill to the first skill based on an input of the first skill and an output of the dependent skill.

In some embodiments the method may include generating the skill graph comprises identifying a set of compatible skills by determining a compliance between each skill of the set of compatible skills with the first skill.

In some embodiments the method may include generating the skill graph by identifying and a set of incompatible skills by determining a compliance mismatch between each skill of the set of compatible skills with the first skill, wherein the compliance mismatch is based on a hardware conflict, a software version, a functionality conflict, or a security requirement.

In some embodiments the method may include compiling the command including the workflow and the first skill comprises aggregating the first skill and at least one additional skill into the workflow. The method may further include building an executable software application based on the workflow.

In some embodiments, the method may include executing the command by generating a runtime instance of the command to perform the workflow.

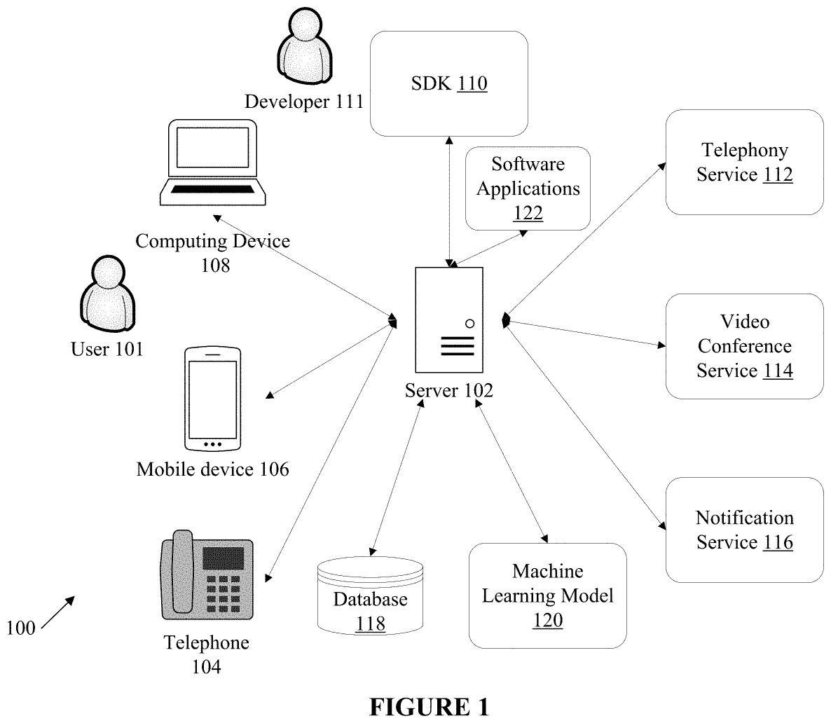

Turning now to the figures, FIG. 1 depicts an example of virtual assistant system 100 for providing a virtual productivity assistant, according to embodiments of the present disclosure. In one example, the virtual assistant system 100 may provide services to a user 101 via a computing device 108, a mobile device 106, and a telephone 104 (e.g., an office telephone, a video phone, etc.). The computing device 108 and the mobile device 106 may each execute a virtual productivity assistant software application 122. The virtual productivity assistant executed on the computing device 108 or the mobile device 106 may communicate with server that provides a backend processing functionality for the virtual productivity assistants. Although only one user having two electronic devices are illustrated, it should be recognized that any number of users and/or electronic devices may be used to implement the virtual assistant system 100. While a computing device 108 and a mobile device 106 are depicted, it should be appreciated that in addition or alternatively, wearable electronics, authentication devices, smart speakers, and other electronic devices may be used to perform the functions described with regard to computing device 108 or mobile device 106.

In some embodiments, the virtual productivity assistant software application 122 of a first user may communicate with another instance of virtual productivity assistant software application of a second user. The virtual assistant system may coordinate communications between any number of virtual productivity assistant software application of any numbers of users, groups, or the like.

The server 102 may provide a developer 111 access to a software development kit 110 to create, update, or delete skills using a graphical user interface provided to the developer 111. The server 102 may be a physical server, a cloud based server, combinations thereof, or the like. The server 102 may access a database 118 that may store details relating to a plurality of skills, pre-defined or previously created commands or skills. The database 118 may further include details on an organization, such as an organizational directory, hierarchy, member's calendars, contacts, etc. Other databases may be included as is necessary and/or desired. The server 102 may further access a plurality of services, such as telephony service 112, video conference service 114, notification service 116. Any other service may be accessed as is necessary and/or desired.

The computing device 108 and the mobile device 106 may combine with the server 102 to provide the virtual assistant system. While some descriptions herein disclose particular operations or functions as being executed on the computing device 108 or the mobile device 106, it should be appreciated that any of these operations may be performed by the server 102, the computing device 108, or the mobile device 106.

In a non-limiting example, the virtual assistant system may provide the user with one or more executable commands. The virtual assistant system may provide a “declutter calendar” command that provides a reduction of calendar schedule to improve efficiency and health of one or more users of an enterprise calendar system. For instance, a user of the virtual assistant system may request the declutter calendar command that may include a reduction of calendar events skill and may further include a meeting ranking skill. The virtual assistant system may provide the declutter calendar command by executing a workflow that includes the reduction of calendar events skill that removes one or more events from a calendar associated with a user of the enterprise calendar system.

The workflow may include one or more actions or skills that perform tasks that in combination provide the command request. Continuing with the previous example, the virtual assistant system may perform the declutter calendar command by invoking the first skill, which in this example is reduction of calendar events. The virtual assistant system may reduce a number of calendar events from a plurality of events that are scheduled on the calendar of the user of the enterprise calendar system. The virtual assistant system may perform a ranking of the plurality of events and determine a priority for each event on the calendar. The virtual assistant system may rank the plurality of events by analyzing each event to determine a role of each user scheduled to attend the event, a status of confirmed or declined attendance for each user, an organizational department of each user, or the like.

In an extension of the current example, the virtual assistant system may further include a machine learning model 120 that captures activities of the user and learn a preference of the user that determines a priority of cancellation for events on the calendar of the user. For instance, the machine learning model 120 may determine that a user prefers to cancel or reschedule a recurring meeting with internal personnel rather than a meeting (recurring or one time) with attendees that are external to the user's organization. The machine learning model 120 may also determine that the user prefers not to cancel or reschedule events that include personnel of a certain role (e.g., senior managers, executives, etc.). The machine learning model 120 may also determine that a meeting includes a customer based on analyzing the event attendees and determining a match between one or more attendees and a customer relationship management tool. The machine learning model 120 may also monitor the user's activity during one or more events and classify the user as a main speaker, an ancillary speaker, or an audience member (e.g., a non-speaker). The machine learning model 120 may determine the classification of the user based on a length of time input from an audio or video system of the user is being received (e.g., the user is speaking into the microphone or audio/video input device).

The machine learning model 120 may further predict a classification of the user with respect to upcoming events on the calendar of the user. For instance, the machine learning model 120 may predict that the user is an audience member of a first upcoming event, an ancillary speaker of a second upcoming event, and a main speaker of a third upcoming event. The machine learning model 120 may apply a weight to the events based on classification of user, and the attendees (as described above) to determine a total priority of the upcoming events. The machine learning model 120 may output the weights or a recommendation for a priority of cancellation or rescheduling in response to the request to execute the declutter calendar command.

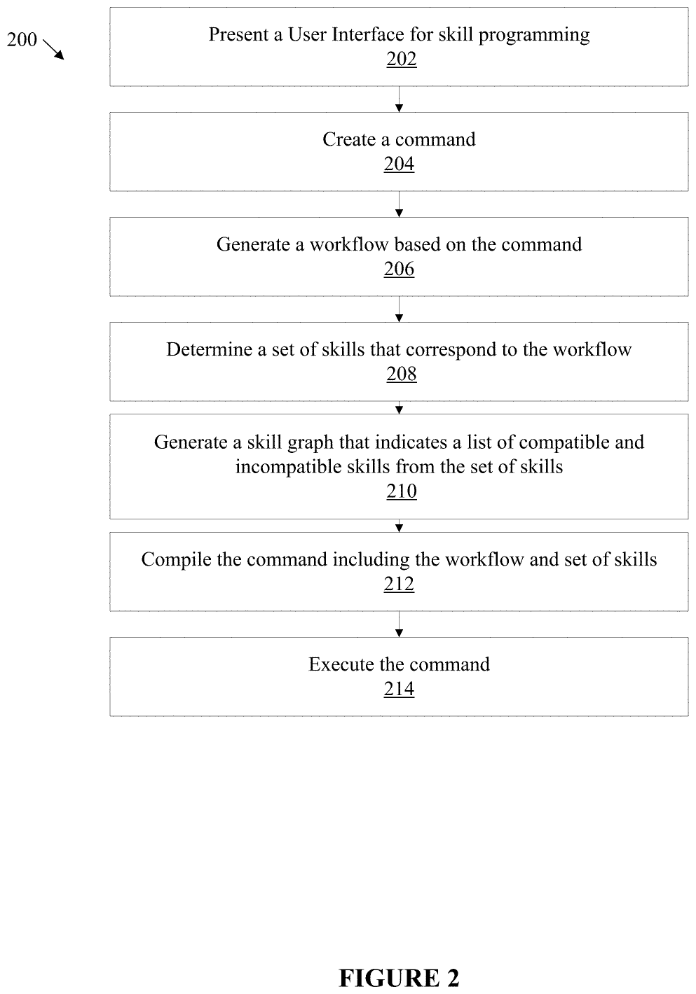

In some embodiments, the virtual assistant system may use information about the ranking of calendar events to not only reduce calendar event density for the user to increase productivity or higher priority tasks, but also to prompt the user for recommended times to take regular breaks that will improve a wellness score of the user while also not interrupting them from important meetings/tasks of that have a priority greater than a threshold priority. The virtual assistant system disclosed herein improve the wellness of the user because the virtual assistant system learns and customizes the response for each user of the system. In other embodiments, the virtual assistant system may recommend that a user get up and move around to also promote wellness. The virtual assistant system may also provide a skill to the user that may transfer an active current call/meeting in which the virtual assistant system determines the user to be a passive participant to your phone (e.g., the user is on mute/not actively speaking) but will prevent a transfer if the virtual assistant system determines the user is the presenter (e.g., the user is on actively speaking, screen sharing, or has a moderator role).FIG. 2 depicts a process flow for providing a virtual productivity assistant is illustrated, according to embodiments of the present disclosure.

At step 202, a virtual productivity assistant software application present a user interface for skill programming. The virtual assistant system may present a development environment in a user interface to one or more developers. The virtual assistant system may provide a set of tools for the developer to customize a visual layout of the user interface. The virtual assistant system may present, based on the developer's requested visual layout, a set of available commands, skills, or high level tasks to prompt the developer to begin building custom commands or groups of commands.

At step 204, the virtual productivity assistant software application may create a command. In one embodiment, the virtual productivity assistant software application may receive a selection from the developer via the user interface. In one example, the selection may include a preset command name, a dynamic command name provided in the selection by the developer, and an identification of the developer. For a dynamically created command, the virtual productivity assistant software application may allocate memory, processor capacity, or other computing attributes of the server to accommodate execution of the new command. The virtual productivity assistant software application may instead allocate cloud computing resources to the new command.

In a non-limiting example, a developer creates a “join meeting” command using the user interface. The virtual assistant system may store the name and identification in the database. The virtual assistant system may allocate one or more processors, a partition of memory, or cloud computing resources to “join meeting.” In some embodiments, the virtual assistant system may provide the developer a prompt for initial allocation recommendations such as a RAM, processor computing, or network bandwidth allocation. The virtual assistant system may allocate the values provided by the developer, or may adjust the values based on a predetermined additional value, a learned additional value associated with previous commands created by the developer, a network priority associated with the identification of the developer, or other factors.

The virtual productivity assistant software application may determine the learned additional value associated with previous commands created by the developer by monitoring one or more developer accounts and commands that are created associated with the one or more developer accounts. The virtual assistant system may include a machine learning model that is trained to generate associations between developers and a plurality of previously generated commands. The machine learning model may determine that one or more developer accounts allocates an overage of computing resources by a percent (e.g., 10% over allocation) and store this value as the learned additional value. The virtual assistant system may use the learned additional value to adjust the resources allocated to the command.

At step 206, the virtual productivity assistant software application may generate a workflow based on the command. For instance, the virtual productivity assistant software application may create a series of related actions based on the command. In one example, the virtual productivity assistant software application may generate the workflow which may be a framework to associate the series of related actions. The workflow may include any number of skills, actions, or groups thereof. The workflow may be further customizable by the developer.

At step 208, the virtual productivity assistant software application may determine a set of skills that correspond to the workflow. For instance, the virtual assistant system may access the database to determine one or more skills that correspond to the workflow. In one example, the virtual assistant system may determine that a “join meeting” skill is associated with a telephone device skill that provides a calling function. The “join meeting” skill may also be associated with a “do not disturb” skill on the mobile device or the computing device to prevent interruption during a length of the meeting. The “join meeting” skill may also determine another skill that notifies other users that are attendees of the meeting or who are associated with the user in an organization (e.g., an assistant, a colleague, or a supervisor) that the user has initiated joining the meeting is associated with “join meeting.”

The virtual assistant system may also include a machine learning application that learns commands that are related to skills. For instance, the virtual assistant system may determine that one or more skills have been added by developers to a particular command or similar commands. The virtual assistant system may determine, based on the frequency, type of command, or other related skills of the commands. For example, the virtual assistant system may determine that a “telephone” skill is associated with the command “join meeting” based on a “conference call” command that includes the “telephone” skill. In another example, the virtual assistant system may determine that the “telephone” skill is associated with a percentage of tasks that involve a calendar application of the user (e.g., meetings, calls, etc.) and thus associate the “telephone” skill with the “join meeting” command based on an association of the “join meeting” with the calendar application.

The virtual assistant system may also include a machine learning application (e.g., the same machine learning application described above or a separate machine learning application) that learns skills that are used by a set of developers. For instance, the virtual assistant system may determine that a set of developers create commands that involve a common set of skills with a threshold frequency (e.g., a similarity score of developers) or that the set of developers create similar commands because of their position in an organizational chart, an association with particular software development packages (e.g., developers for customer resource management software, developers for accounting software, developers for user support, etc.). The virtual assistant system may determine that a “reminder” skill is associated with the set of developers who are associated with user support applications (e.g., e-mail, calendar, automating office tasks, etc.). The virtual assistant system may associate the “reminder” skill with any commands past or present created by the developers who are assigned to user support applications.

At step 210, the virtual productivity assistant software application may generate a skill graph that indicates a list of compatible and incompatible skills from the set of skills. The virtual assistant system may generate, for presentation in the skill programming interface, a visual rendering of the relationships between skills and the workflow. For example, the virtual assistant system may generate a first list of compatible skills with the workflow that includes an indication that the compatible skills have been verified as compliant with the workflow. The virtual assistant system may generate a second list of incompatible skills that includes an indication that the incompatible skills have been verified as having a compliance mismatch with the workflow. The virtual assistant system may determine that a skill is compatible or incompatible based on a version of software applications relating to the skill, a functionality conflict (e.g., an unsecure telephone system is not compliant with a security requirement, etc.), or a hardware conflict (e.g., requires a particular device to be used). The user interface may provide for display, a graph of the two lists of skills. In some embodiments, the virtual assistant system may provide a tree-like structure that depicts relationships of skills and compatibility. In the tree-like structure, the user interface may be configured to receive a selection from the developer of an incompatible skill and remove that incompatible skill from the workflow. In some embodiments, the virtual assistant system may provide the developer with a recommended replacement skill for incompatible skills.

At step 212, the virtual productivity assistant software application may compile the command including the workflow and the set of skills. For instance, the virtual assistant system may compile each skill in the workflow and build the workflow into an executable software application or configuration file for instituting a micro-service. The virtual assistant system may use a compiler appropriate for the programming language or development environment.

At step 214, the process 200 involves executing the command. The virtual assistant system may receive, after compilation, a request to execute the command by one or more users. The virtual assistant system may generate a runtime instance of the command and associated workflow for execution by a processor of the computing device, the mobile device, or the server 102.

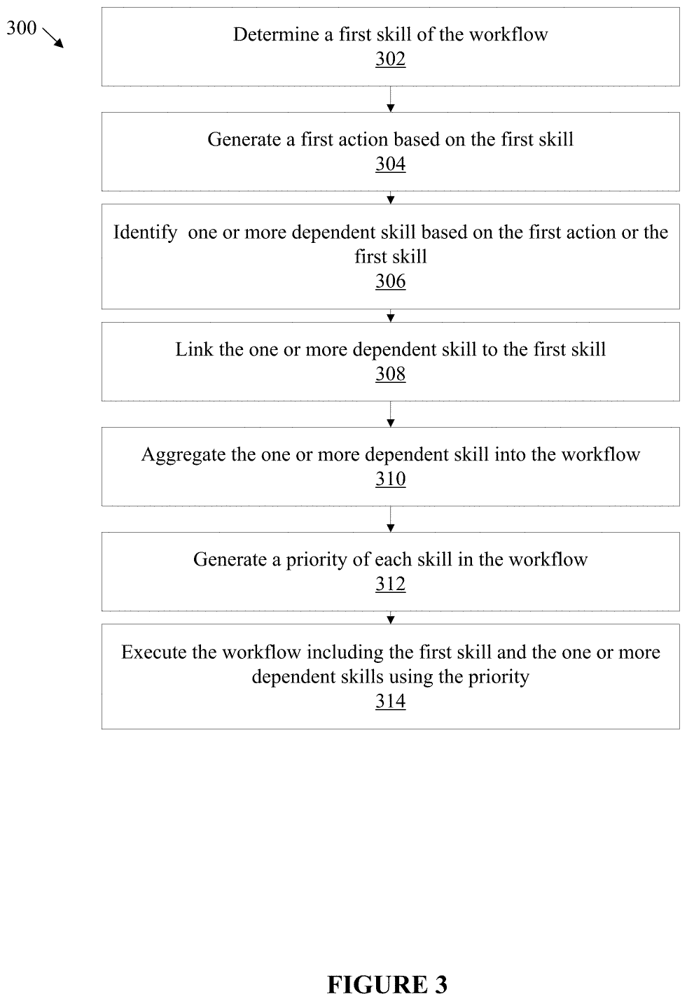

FIG. 3 depicts an example of generating a workflow for a virtual productivity assistant is illustrated, according to embodiments of the present disclosure.

At step 302, the virtual productivity assistant software application may determine a first skill of a workflow for a virtual productivity assistant. Continuing with the non-limiting example from FIG. 2, the virtual assistant system may receive a request to create the command “join meeting” from the developer. The virtual assistant system may access the database to determine a set of related skills as described herein. The virtual assistant system may rank the related skills by relevance or occurrence and return a first skill to the developer. For instance, the virtual assistant system may determine that “join a meeting” requires authentication of the user prior to accessing a calendar, telephone, or communication system by the user. Accordingly, the virtual assistant system may determine that the authentication skill is a greater priority than the other skills.

At step 304, the virtual productivity assistant software application may generate a first action based on the first skill. Continuing with the previous example, the virtual assistant system may generate a first action “request credential from the user” based on the first skill to authenticate the user as determined at step 302. The virtual assistant system may further generate additional actions such as “verify the credential of the user” or “determine authentication level of the credential” based on a particular configuration of the authentication skill.

In some embodiments, more than one action may be generated based on the first skill. For instance, while the process at step 304 is described in the context of generating a first action, it should be appreciated that the virtual assistant system may be configured to generate a first set of actions based on the first skill. In these embodiments, the set of first actions may include a plurality of actions, such as “request credential from the user,” “verify the credential of the user” or “determine authentication level of the credential” in a discrete set of actions.

In other embodiments, the virtual assistant system may generate actions based on detecting a location of the user or resources available to the user. The virtual assistant system may detect that the user is in an office location (i.e., an office location, or a desk within the office location) or working from a remote location. The virtual assistant system may determine a set of telephony devices are available to you at that location (can be variable for each desk within the office location or at a remote location). The virtual assistant system may suggest the best way for the user to join meetings from the specific location (e.g., a desk) where the user is located to provide the highest fidelity possible for meetings. The virtual assistant system may automatically place the user into one or more meetings. The virtual assistant also provides the user a mobile join meeting action through a mobile phone associated with the user that is executing a virtual assistant productivity software application to complete a handover of meeting control from the instance running on the telephony device to the phone.

At step 306, the virtual productivity assistant software application may identify one or more dependent skills based on the first action or the first skill. The virtual assistant system may access the database to determine related skills, such as a skill that depends on the first skill. Continuing with the previous example, the virtual assistant system may determine that “join meeting” skill may depend on an authentication skill as described with respect to steps 302-304. The virtual assistant system may further determine that the authentication skill depends on a credentialing skill. Additionally or alternatively, the virtual assistant system may determine that the: join meeting” skill also depends on a calendar skill. The virtual assistant system may determine that the calendar skill further depends on a system time skill and time zone skill to coordinate access to the meeting at a scheduled time based on the system time and the time zone of the user.

At step 308, the virtual productivity assistant software application may link the one or more dependent skills to the first skill. The virtual assistant system may generate an association between the first skill and dependent skills. The virtual assistant system may store these associations in the database. In some embodiments, the virtual assistant system may provide the linked skills for other applications as a recommended skill group. The virtual assistant system may learn relations between linked skill groups based on a frequency of use together or dependent skills that are common between one or more of the skills in the skill group.

At step 310, the virtual productivity assistant software application may aggregate the one or more dependent skills into the workflow. The virtual assistant system may aggregate the one or more dependent skills into the workflow in an order based on the dependency or priority, or both. For instance, as described above, the virtual assistant system may determine that a first skill has a plurality of dependent skills. The virtual assistant system may rank the dependent skills such that a selected dependent skill has a further dependent skill that depends on both the first skill and the selected dependent skill. The virtual assistant system may aggregate the selected dependent skill and/or the further dependent skill into the workflow.

The virtual assistant system may determine that one or more inputs/outputs or events may be required before the selected dependent skill or the further dependent skill may be executed. In some embodiments, the virtual assistant system may determine that a first subset of the one or more dependent skills may be performed in parallel while a second subset of the one or more dependent skills may be compatible for only serial execution.

At step 312, the virtual productivity assistant software application may generate a priority of each skill in the workflow. The virtual assistant system may determine a priority of each skill in the workflow by analyzing the skill, the dependent skills, and the computing resources required to execute each skill. In some cases, the virtual assistant system may further determine the priority based on a sequence of the inputs and outputs of the skills in the workflow. The virtual assistant system may also determine the priority of each skill based on one or more user accounts accessed by the skill, a privacy or confidentiality factor of the skill, or an authentication level required for execution of the skill.

In one example, the virtual assistant system may generate a numerical score that indicates priority (e.g., priority 1, priority 2, priority 3, etc.), or another priority metric that indicates priority level of each skill. The virtual assistant system may assign priority levels for each skill to customize the experience for each individual user by processing the skills and commands through machine learning to determine a set of skills or commands that the individual user prefers or invokes with higher frequency. The virtual assistant system may optimize the user interface for a small format that delivers highly responsive interactions. The virtual assistant system may present skills or commands to the user in a dynamically defined order based on the machine learning for each individual user. The virtual assistant system may further determine a location or available resources/devices to determine the priority.

In another example, the virtual assistant system may determine a likely intent of the user. For instance, the virtual assistant system may determine that a peer user (e.g., a colleague with an association such as same work department, common calendar events) is initiating a search for the user by typing in the first 3 letters of a legal name. The virtual assistant may invoke a standard identification (SID) skill that presents contact information in the interface of the peer associated with the peer user's SID user based on past usage. Additionally, the virtual assistant system may user other factors to prioritize information presented to the peer user. Other factors include a location of the peer user and a location of the user, an activity of the peer user and the user such as participating in a meeting or a call, a usage of a particular application, other users that have previous interactions with the peer user or the user, a time of day or time zone (e.g., the peer user is located in the United States—so it may be less likely that a search for a user in a location where it is off work hours), commands that have been invoked previously. In some embodiments, the virtual assistant system may tailor a relevance of a subset of skills to specific groups of users based on predetermined or learned attributes associated with the group of users.

At step 314, the process 300 involves executing the workflow including the first skill and the one or more dependent skills using the priority of each skill. The virtual assistant system may generate a runtime instance of the workflow and associated workflow for execution by a processor of the computing device, the mobile device, or the server 102.

Additional details, embodiments, and examples are found in the attached appendix, which is incorporated, by reference, in its entirety.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method of providing a virtual productivity assistant, the method comprising:
presenting, by a computer program, a skill programming interface;
receiving, by the computer program and from the skill programming interface, a user input;
creating, by the computer program, a command based on input received by the skill programming interface;
generating, by the computer program, a workflow based on the command, wherein the workflow includes a first skill associated with the command;
identifying, by the computer program, a dependent skill from a plurality of dependent skills based on the first skill and the command;
generating, by the computer program, a skill graph comprising a set of compatible skills and a set of incompatible skills;
compiling, by the computer program, the command including the workflow and the first skill; and
executing, by the computer program, the command.

2. The method of claim 1, wherein identifying, by the computer program, a dependent skill from a plurality of dependent skills based on the first skill and the command comprises:
accessing, by the computer program, a database including a plurality of skills; and
linking, by the computer program, a dependent skill to the first skill, wherein linking comprises generating, by a machine learning model, an association between the dependent skill to the first skill based on an input of the first skill and an output of the dependent skill.

3. The method of claim 1, wherein generating the skill graph comprises identifying a set of compatible skills by determining a compliance between each skill of the set of compatible skills with the first skill.

4. The method of claim 1, wherein generating the skill graph comprises identifying and a set of incompatible skills by determining a compliance mismatch between each skill of the set of compatible skills with the first skill, wherein the compliance mismatch is based on a hardware conflict, a software version, a functionality conflict, or a security requirement.

5. The method of claim 1, wherein compiling the command including the workflow and the first skill comprises:
aggregating the first skill and at least one additional skill into the workflow; and
building an executable software application based on the workflow.

6. The method of claim 1, wherein executing the command comprises generating a runtime instance of the command to perform the workflow.

7. A system for providing a virtual productivity assistant, the system comprising:
a computer-readable medium storing instructions that, when executed by a processor, cause the processor to perform a method comprising:
presenting a skill programming interface;
receiving a user input;
creating a command based on input received by the skill programming interface;
generating a workflow based on the command, wherein the workflow includes a first skill associated with the command;
identifying a dependent skill from a plurality of dependent skills based on the first skill and the command;
generating a skill graph comprising a set of compatible skills and a set of incompatible skills;
compiling the command including the workflow and the first skill; and
executing the command.

8. The system of claim 7, wherein identifying the dependent skill from a plurality of dependent skills based on the first skill and the command comprises:
accessing a database including a plurality of skills; and
linking a dependent skill to the first skill, wherein linking comprises generating, by a machine learning model, an association between the dependent skill to the first skill based on an input of the first skill and an output of the dependent skill.

9. The system of claim 7, wherein generating the skill graph comprises identifying a set of compatible skills by determining a compliance between each skill of the set of compatible skills with the first skill.

10. The system of claim 7, wherein generating the skill graph comprises identifying and a set of incompatible skills by determining a compliance mismatch between each skill of the set of compatible skills with the first skill, wherein the compliance mismatch is based on a hardware conflict, a software version, a functionality conflict, or a security requirement.

11. The system of claim 7, wherein compiling the command including the workflow and the first skill comprises:
aggregating the first skill and at least one additional skill into the workflow; and
building an executable software application based on the workflow.

12. The system of claim 7, wherein executing the command comprises generating a runtime instance of the command to perform the workflow.

13. A system for providing a virtual productivity assistant, the system comprising:
a user device configured to present a graphical user interface; and
a server comprising a computer-readable medium storing instructions that, when executed by a processor, cause the processor to perform a method comprising:
presenting a skill programming interface;
receiving a user input;
creating a command based on input received by the skill programming interface;
generating a workflow based on the command, wherein the workflow includes a first skill associated with the command;
identifying a dependent skill from a plurality of dependent skills based on the first skill and the command;
generating a skill graph comprising a set of compatible skills and a set of incompatible skills;
compiling the command including the workflow and the first skill; and
executing the command.

14. The system of claim 13, wherein identifying the dependent skill from a plurality of dependent skills based on the first skill and the command comprises:
accessing a database including a plurality of skills; and
linking a dependent skill to the first skill, wherein linking comprises generating, by a machine learning model, an association between the dependent skill to the first skill based on an input of the first skill and an output of the dependent skill.

15. The system of claim 13, wherein generating the skill graph comprises identifying a set of compatible skills by determining a compliance between each skill of the set of compatible skills with the first skill.

16. The system of claim 13, wherein generating the skill graph comprises identifying and a set of incompatible skills by determining a compliance mismatch between each skill of the set of compatible skills with the first skill, wherein the compliance mismatch is based on a hardware conflict, a software version, a functionality conflict, or a security requirement.

17. The system of claim 13, wherein compiling the command including the workflow and the first skill comprises:
aggregating the first skill and at least one additional skill into the workflow; and
building an executable software application based on the workflow.

18. The system of claim 13, wherein executing the command comprises generating a runtime instance of the command to perform the workflow.
